(19) United States
(12) Patent Application Publication
(10) Pub. No.: US 2007/0283750 A1
(43) Pub. Date: Dec. 13, 2007

(54) Tire Sensitivity Recognition Method

(75) Inventors: Martin Griesser, Eschborn (DE); Andreas Kobe, Bensheim (DE); Frank Edling, Kanagawa (JP); Vladimir Koukes, Darnstadt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG, Frankfurt (DE)

(21) Appl. No.: 11/578,016

(22) PCT Filed: Apr. 1, 2005
(86) PCT No.: PCT/EP05/51470

§ 371 Date: Aug. 6, 2007

(30) Foreign Application Priority Data
Apr. 7, 2004 (DE) 102004017582.9

(51) Int. Cl. G01M 17/02

(52) U.S. Cl. 73/146

(57) ABSTRACT

A method of detecting the tire sensitivity is described. The method includes determining the tire load Fₜᵢᵣₑ of the vehicle, determining rotational speed information of the wheels, determining the tire sensitivity from the variation of the wheel rotational speed information depending on the variation of the tire load Fₜᵢᵣₑ.

### BACKGROUND OF THE INVENTION

The present invention relates to a method of detecting the tire sensitivity and to a computer program product. The method includes determining the tire load Ftire of the vehicle, determining rotational speed information of the wheels, and determining the tire sensitivity from the variation of the wheel rotational speed information depending on the variation of the tire load Ftire. The computer program product defines an algorithm which comprises the method.

It is of great significance for vehicle safety to reliably monitor the tire inflation pressure on all wheels of a motor vehicle or a motorcycle. DE 100 58 140 A1 discloses a so-called indirectly measuring tire pressure monitoring system (e.g. DDS: Deflation Detection System), which detects an inflation pressure loss at the wheels based on wheel rotational speed data, such as the rolling circumferences.

It has shown that the tire sensitivity, i.e. the change of the rolling circumference of the tire due to tire pressure loss, will be different in different types of tires. Erroneous alarms or omission of alarms of the indirectly measuring tire pressure monitoring system can occur as a result.

In view of the above, an object of the invention is to provide a method for detecting the tire sensitivity.

### SUMMARY OF THE INVENTION

This object is achieved by a method for determining the tire load Ftire of the vehicle, determining rotational speed information of the wheels, and determining the tire sensitivity from the variation of the wheel rotational speed information depending on the variation of the tire load Ftire.

### BRIEF DESCRIPTION OF THE DRAWINGS

Further features of the invention can be seen in the sub claims and the subsequent description by way of the Figures. In the drawings:

FIG. 1 is a first flow chart,

FIG. 2 is a second flow chart, and

FIG. 3 shows the lateral acceleration aₗₐₜ as a function of a time quotient.

### DETAILED DESCRIPTION OF THE DRAWINGS

The dependency of the dynamic roll radius ΔR_{dyn} as a function of the inflation pressure loss Δp differs to a large degree as regards different sets of tires. In indirectly measuring tire pressure monitoring systems (DDS: Deflation Detection System), the change of the dynamic rolling circumference ΔR_{dyn} is used as an indicator of tire pressure loss. When a fixed warning threshold for a defined change of the dynamic rolling radius is used for an indirectly measuring tire pressure monitoring system, a warning with respect to inflation pressure loss occurs for different types of tire at different levels of tire pressure.

In order to adapt the warning thresholds to the type of tire actually mounted on the vehicle, the dependency, hereinbelow referred to as tire sensitivity, of the dynamic rolling radius ΔR_{dyn} must be known as a function of the inflation pressure loss Δp for this type of tire. The method of the invention determines in this respect the tire sensitivity of a type of tire actually mounted on the vehicle.

Two methods (method 1 and method 2) for determining the tire sensitivity are proposed.

In method 1, the physical effect is measured by means of wheel speed sensors in order to determine the tire sensitivity. There are two effects, which condition the tire sensitivity:

Effect 1.1: growth of the tire contact area: the greater the relative growth of the tire contact area in a longitudinal direction of a tire depending on the inflation pressure loss, the higher the rate of tire sensitivity.

Effect 1.2: wheel torque dependency: the ‘softer’ a tire is (e.g. the rubber compound of winter tires is softer than that of summer tires), the more the tire sensitivity decreases depending on the wheel torque. Example: A winter tire at low wheel torques exhibits almost the same tire sensitivity as a summer tire, but it is much more insensitive at higher wheel torques.

The evaluation of the effect 1.1 allows setting a basic warning threshold depending on the tire sensitivity. In order to obtain a more exact detection of soft tires, the effect 1.2 is assessed, whereby a warning threshold is lowered at high wheel drive torques.

Initially, the tire sensitivity is determined depending on the growth of the tire contact area (effect 1.1). When the inflation pressure of a tire decreases, the tire contact area and, hence, also the dynamic rolling circumference will change depending on the tire sensitivity. The indirectly measuring tire pressure monitoring system detects the change of the dynamic rolling circumference, and a warning with respect to inflation pressure loss is output.

Another variable, which causes growth of the tire contact area, is the tire load Fₜᵢᵣₑ. The higher the tire load Fₜᵢᵣₑ, the larger the tire contact area. A force signal of an active chassis system can be used as an indicator of the tire load. In the absence of such a signal, the tire load must be estimated. To this end, the actual lateral acceleration aₗₐₜ, which exists, for example, as an input signal of an electronic stability program (ESP), is used to assess the change of the tire load.

The tire load Fₜᵢᵣₑ is assessed from the lateral acceleration aₗₐₜ using a vehicle model. The tire load Fₜᵢᵣₑ causes a change of the dynamic rolling circumference at the tire. The latter circumference can be determined by means of the speed measured with wheel speed sensors. This interrelation (tire load change—change of the dynamic rolling circumference) is used to determine the tire sensitivity.

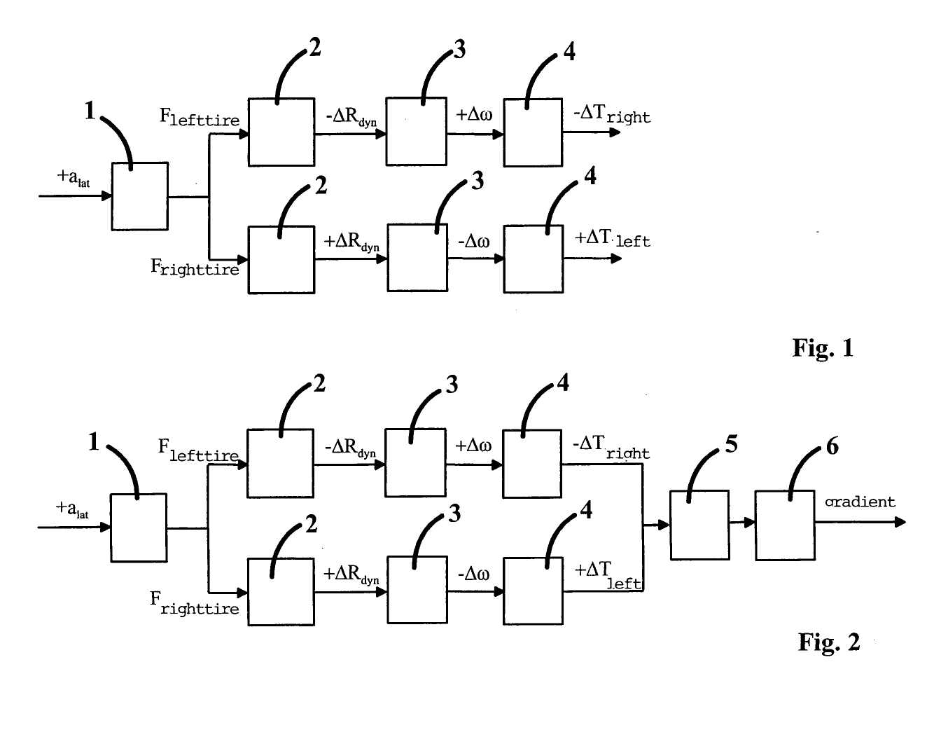

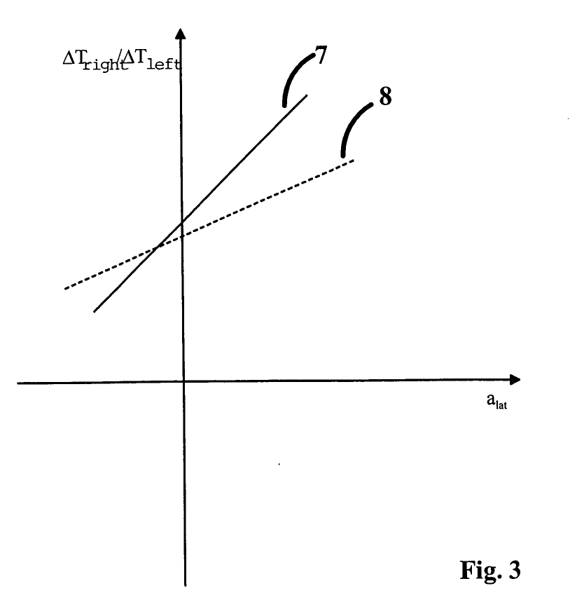

A lateral acceleration aₗₐₜ of the vehicle is e.g. caused by a cornering maneuver, when the outside wheels in a turn are subjected to higher load than the inside wheels in a turn, with the result that the tire load Fₜᵢᵣₑ of the outside wheels in a turn increases, while the tire load Fₜᵢᵣₑ of the inside wheels in a turn decreases. The influence of the lateral acceleration aₗₐₜ is determined by a comparison of the wheel speeds ω on an axle. To this end, the distribution of the tire load for the respectively left (F_{left tire}) and for the right (F_{right tire}) wheels is calculated from the lateral acceleration aₗₐₜ using a vehicle model 1 (see FIG. 1). Due to the change or the shift of the tire loads (F_{left tire} and F_{right tire}) in a cornering maneuver, the dynamic rolling circumference of the inside and the outside wheels in a turn (−ΔR_{dyn} and +ΔR_{dyn}, represented by reference numeral 2) will change as well, with the result of a change of the wheel speeds (+Δω and −Δω) of the respective wheels (represented by reference numeral 3) occurring. An indirectly measuring tire pressure monitoring system measures and assesses the wheel speeds or variables depending thereon, such as the wheel revolution times, for detecting an inflation pressure loss. Thus, if there is a change in wheel speeds due to lateral acceleration, this will also be mirrored in the assessment of an indirectly measuring tire pressure monitoring system (represented by reference numeral 4). If, for example, the indirectly measuring tire pressure monitoring system determines times as input variables, e.g. a defined number of pulses of the pulse generator wheel of a wheel speed sensor, the variations of these times (−ΔT_{right} and +ΔT_{left}) are determined for the respective wheel. When a quotient (ΔT_{right}/ΔT_{left}) is determined from the variations of the times (−ΔT_{right} and +ΔT_{left}) and said quotient is plotted against the lateral acceleration aₗₐₜ, regression lines 7, 8 as illustrated in FIG. 3 are obtained. The gradient of these regression lines 7, 8 describes the sensitivity of the tires at the axle under review. When the above calculation is carried out for all axles, or for all wheels arranged at the axles, an individual tire sensitivity of the wheels at the axle under review in each case is obtained.

ΔT_{right}/ΔT_{left} is not only influenced by the tire load during cornering, but the curve radius per se is the most significant coefficient of influence, which must be compensated.

It is possible to calculate the curve radius from the yaw rate and the vehicle speed. The flow chart in this case is illustrated in FIG. 2. FIG. 2 differs from the flow chart in FIG. 1 in that, based on the variations of the times (−ΔT_{right} and +ΔT_{left}), a quotient 5 (ΔT_{right}/ΔT_{left}) is produced, which is compensated in a compensation step 6 by the influence of the curve radius or by the yaw rate, respectively. An embodiment of the compensation step is the deduction of the compensation value K from the quotient 5. K is calculated as follows, and \dot{ψ} is the yaw rate, S is the track width, and v_{ref} is the speed of the vehicle.

$$K = {k}_{komp} \cdot \frac{\dot{ψ} \cdot S}{{v}_{ref}}$$

The constant kₖₒₘₚ is used for correctly scaling the compensation value.

From this results the gradient of the regression lines 7, 8, as shown in FIG. 3. In this respect, the regression line 7 shows the typical behavior (high gradient) of a sensitive tire, while the regression line 8 reflects the typical behavior (lower gradient) of an insensitive tire. It is advisable to apply this method depending on the wheel torque, e.g. in wheel torque intervals.

Measurements have shown that the above method can be employed only if it is known whether a summer tire or a winter tire has been mounted on the vehicle, because an insensitive winter tire has an almost equal gradient of the regression line as compared to a sensitive summer tire. Nevertheless, this method can be used until it is possible to determine the tire rigidity depending on the wheel torques (effect 1.2).

If, instead of the wheels on an axle, alternatively the wheels on a vehicle side (‘sample side’) are considered as a function of the lateral acceleration, an average tire sensitivity of all wheels is obtained hereby.

When the forces at the diagonal wheel positions differ greatly from each other, it is also possible to use the diagonally arranged wheels (‘sample diag’) for the evaluation.

It shall be assumed in the following that the variation of the force at the front axle depending on the lateral acceleration aₗₐₜ adopts the value zero and that there is a variation of force only at the rear axle. In this case, the sample times ΔT₁, ΔT₂ of the front axle do not have an effect on the calculation, and sample diag=(T1+T3)/(T2+T4)−1 can be used exactly as ΔT_{right}/ΔT_{left}. This assumption leads to a solution when the shifts of force differ greatly, for example, in the event of a heavy front engine and a low rear load.

As long as the force on all wheel positions varies in a large extent depending on the lateral acceleration aₗₐₜ, the preferred assumption is:
ΔT_{right}/ΔT_{left}=f(aₗₐₜ)

When another measurable physical effect apart from the inflation pressure loss is found, which increases the tire contact area, and the dynamic rolling radius can be determined at the same time, the function ΔR_{dyn}=f(effect) can also be used to determine the tire sensitivity.

Hereinbelow, the evaluation of the wheel torque dependency of the tire sensitivity (effect 1.2) will be looked at more intensively. As has been stated hereinabove, the soft tires exhibit reduced tire sensitivity dependent on the wheel torque.

It is possible in the indirectly measuring tire pressure monitoring system (DDS) to take the gradient of the learnt axle references (SAMPLE AXLE) as a function of the wheel torque into account when determining the tire rigidity.
SAMPLE AXLE=(T₁+T₂)/(T₃+T₄)−1 (1)

The axle reference (SAMPLE AXLE) depends on the slip. For vehicles with front-wheel drive applies:
SAMPLE AXLE=SAMPLE AXLE₀−k*λ (2)

For vehicles with rear-wheel drive:
SAMPLE AXLE=SAMPLE AXLE₀+k*λ (3)
applies.

with SAMPLE AXLE₀: initial value of the value SAMPLE AXLE, when the vehicle torque is almost ‘0’; k: proportionality coefficient; λ: slip

The slip is proportional to the wheel torque Tq:
λ=k₁*Tq, (4)

k₁: proportionality coefficient between wheel slip λ and wheel torque Tq.

Therefore:
SAMPLE AXLE=SAMPLE AXLE₀−k₂*Tq (5)
applies to front-wheel driven vehicles and:
SAMPLE AXLE=SAMPLE AXLE₀+k₂*Tq (6)
applies to rear-wheel driven vehicles
with k₂=k*k₁

The proportionality coefficient k₂ is the gradient of the line dependency (equation (4) or (5)). This gradient is proportional to the coefficient of friction:
k₂=μ*k₃ (7)

From equations (4) to (7) follows:

for front-wheel driven vehicles:
SAMPLE AXLE=SAMPLE AXLE₀−k₃*μ*Tq (8)
and for rear-wheel driven vehicles:
SAMPLE AXLE=SAMPLE AXLE₀+k₃*μ*Tq (9)

The coefficient of friction μ is dependent on the rigidity of the tire on the road surface. The coefficient of friction is the higher the lower the rate of tire rigidity is. This means that the gradient of the straight line (equation (7) or (8)) with softer tires is higher than with rigid tires. The influence of the road properties is usually much less significant than the influence of the tire rigidity.

As has been found out, so-called wide base tires have a higher rigidity than narrow tires, and summer tires have a higher rate of rigidity than winter tires. It has also shown that an effective variation of the tire rolling circumference on account of inflation pressure loss is the more significant, the more rigid the tires are. This variation is greater for wide base tires than for small base tires. It is greater for summer tires than for winter tires. These findings are used to adjust the detection thresholds of the indirectly measuring tire pressure monitoring system (DDS) and to determine the tire characteristics.

To this end, first of all the axle reference ‘SAMPLE AXLE’ is learnt. Pairs of values are produced from the values ‘SAMPLE AXLE’ and the wheel torques Tq in the learning operation. A regression line (equation (5) or (6)) is calculated using the method of least squares. The learning operation is not terminated until the regression line has a high correlation coefficient. The learnt values k₂ and SAMPLE AXLE₀ are stored. It is advisable to perform this learning operation in consideration of the vehicle speed, e.g. in speed intervals.

Subsequently, the warning thresholds of the indirectly measuring tire pressure monitoring system (DDS) are adapted. The higher the gradient |k₂| of the regression line (equation (5) or (6)), the less significant is the change of the actual tire circumference in the event of inflation pressure loss. When the gradient is high, the warning thresholds are reduced. A particularly low rate of tire sensitivity at the driven axle is the condition for high wheel torques. When the gradient is low, the warning thresholds for great wheel torques are reduced to a smaller degree.

The information about tire rigidity can be made available to other vehicle systems (e.g. ABS or ESP) as well in order to improve control algorithms.

In method 2, the tire characteristics are determined directly from tire information or tire data being stored in the tire. In this arrangement, tire information is stored e.g. in a transponder, which is arranged in or at the tire. This tire information is transmitted to a control unit in the vehicle. Tire information can have been written into the transponder e.g. during fabrication of the tire or during assembly on the tire in a repair shop. It is also possible that the driver presets the tire information or selects it from a list of types of tires stored in the control unit. Further, the tire information can also be derived from other vehicle components used, such as engine and brake data.

This ‘transponder technology’ will render it possible in the future to store the tire data in a coded form in the tires during the production. Activation and reception antennas at the vehicle allow activating the transponder in the tire from the vehicle so that it sends information, and the latter information can in turn be received in the vehicle and conveyed to a check unit.

With the advent of the transponder technology, it will be possible to send stored parameters in the tire, e.g. the tire rigidity or the tire size (e.g. Continental Sport Contact 225/45R18), to a check unit, which comprises an indirectly measuring tire pressure monitoring system (DDS). The check unit includes a list of tires and tire sensitivities, from which the desired warning thresholds can be read.

Another method could involve writing the tire data into the check unit at the end of the fabrication. The tire information must be updated each time when the tire is exchanged in the repair shop, for example, by means of diagnosis testing tools.

A third approach for the market of the technically skilled drivers (e.g. high-performance sports cars such as the M-series of BMW) is that the drivers take care of the input of tire data by means of a device in the instrument panel.

A fourth method involves deriving the maximum tire size from data of the brake discs and/or the engine data in the vehicle. Many manufacturers do not offer the maximum sizes of tires for vehicles with low engine power. Therefore, the system can be adapted to small sized tires when the engine control unit outputs related information. When the brake disc information is stored in the check unit, the minimum rim size is known because the rim must be larger than the brake disc. By adding this information to a list of the manufacturer relating to tire-engine combinations it is possible to estimate the range of the possible tires mounted at the vehicle, in order to set the warning thresholds.

1-11. (canceled)

12. A method for determining tire sensitivity, the method comprising:
determining a tire load Ftire of a vehicle, wherein the vehicle has two or more wheels;
determining rotational speed information of the wheels;
determining a tire sensitivity from a variation of the wheel rotational speed information depending on a variation of the tire load Ftire.

13. A method according to claim 12, wherein the tire load Ftire is determined using a tire load sensor or any other chassis sensor.

14. A method according to claim 13, wherein the tire load Ftire is determined from a lateral acceleration aₗₐₜ of the vehicle.

15. A method according to claim 14, wherein the lateral acceleration aₗₐₜ is measured using a lateral acceleration sensor.

16. A method according to claim 13, wherein rotational speed information, such as wheel revolution time, wheel speed, or wheel rolling circumference, of the wheels is determined by wheel speed sensors.

17. A method according to claim 12, wherein the tire sensitivity is determined by considering or compensating the curve radius.

18. A method according to claim 17, wherein the curve radius is determined by evaluating the yaw rate and the speed of the vehicle.

19. A method according to claim 12, wherein the tire sensitivity is defined in consideration of the wheel torques.

20. A method according to claim 12, wherein the tire sensitivity is determined for an anti-lock system (ABS) or an electronic stability program (ESP).

21. A method according to claim 12, wherein the tire sensitivity is used in an indirect measuring tire pressure monitoring system.

22. A computer program product comprising:
an algorithm stored in the product, wherein the algorithm defines a method for determining tire sensitivity comprising:
determining a tire load Ftire of a vehicle, wherein the vehicle has two or more wheels;
determining rotational speed information of the wheels;
determining a tire sensitivity from a variation of the wheel rotational speed information depending on a variation of the tire load Ftire.
